(19) United States
(12) Patent Application Publication
(10) Pub. No.: US 2024/0383200 A1
(43) Pub. Date: Nov. 21, 2024

(54) 3D PRINTING SYSTEM AND METHOD FOR SUPRESSING LIGHT REFLECTION AND SCATTERING

(71) Applicants: Michael Begarney, Columbia, NJ (US); Michael Clifford, Westtown, NY (US)

(72) Inventors: Michael Begarney, Columbia, NJ (US); Michael Clifford, Westtown, NY (US)

(21) Appl. No.: 18/656,722

(22) Filed: May 7, 2024

Related U.S. Application Data
(60) Provisional application No. 63/467,166, filed on May 17, 2023.

(51) Int. Cl. B29C 64/30; B05D 5/06; B33Y 10/00; B33Y 30/00; B33Y 40/20; B33Y 80/00

(52) U.S. Cl. CPC B29C 64/30; B05D 5/06; B33Y 10/00; B33Y 30/00; B33Y 40/20; B33Y 80/00

(57) ABSTRACT

Systems, methods, and other embodiments for printing products having 3-dimensional lattice surfaces, including providing a plurality of additive manufacturing (AM) units each adapted to produce a product having 3-dimensional lattice surfaces using additive manufacturing (AM), determining a desired surface lattice to print upon a surface of the product, printing the desired surface lattice on the surface of the product, wherein the desired surface lattice is capable of reducing and controlling a light reflection and a light scattering of light that interacts with the surface lattice on the product, determining a desired surface porosity coating to print upon the desired surface lattice, and printing the desired surface porosity coating upon the desired surface lattice, wherein the desired surface porosity coating is capable of further reducing a light reflection and a light scattering of light that interacts with the surface lattice.

### CROSS-REFERENCE TO RELATED APPLICATION

This application claims benefit of U.S. Patent Application No. 63/467,166, filed on May 17, 2023, the disclosure of which is hereby incorporated by reference in its entirety to provide continuity of disclosure to the extent such a disclosure is not inconsistent with the disclosure herein.

### FIELD OF THE INVENTION

The present invention is generally related to 3D printed surfaces having 3-dimensional features that range from less than 1 micron to greater than 10 mm (10,000 micron), by combining geometric design elements, such as surface lattices, with other processes. Such processes may be special laser sintering processes, heat treatment processes, or chemical treatment processes. Also, the surface lattices have characteristics, such as high surface area, that make them useful for certain applications, such as absorption and emission of electromagnetic radiation, suppression of light reflection and light scattering, and trapping of small particles. For example, the present invention is expected to have applicability in the field of optical assemblies, in particular, surface layers on the internal surfaces of optical assembly housings, in which stray light or scattered light beams are not desired to reach a particular optical sensor or receiving optical element.

### BACKGROUND OF THE INVENTION

Prior to the present invention, as set forth in general terms above and more specifically below, it is known to use 3D printing techniques to “print” or construct various structures having intricate shapes. For example, it is known to use 3D printing techniques to create structures that can be used in a variety of optical devices.

It is also known that certain optical devices need to be constructed such that stray light or scattered light beams do not interact with a particular optical sensor or receiving optical element within the optical device. Towards this end, in one embodiment, it is known to coat the inner surfaces of the optical device in order to substantially reduce the amount of light reflection and control and minimize light scattering within the optical device.

Typically, the coating is applied to the inner surface of the optical device through conventional coating techniques such as spraying, painting or the like. While these known techniques of applying the coating to the inner surface of the optical device produce a coating within the optical device that is capable of reducing light reflection and controlling and minimizing light scattering within the optical device, the coating application process is time consuming and expensive. Furthermore, the coating application processes utilize coating materials that can be hazardous and require special equipment and training. Finally, the coatings may degrade prematurely, thereby reducing the performance and service lifetime of the device, and may also emit byproduct chemical species, thereby making them incompatible for certain environments or applications.

Finally, the current methods of creating the 3D printed structures and then coating the inner surfaces of the 3D printed structures require weeks to months to construct a final device having a coated interior surface to reduce light reflectivity and control and minimize light scattering within the device.

It is a purpose of this invention to fulfill these and other needs in the art of producing an optical device in a manner more apparent to the skilled artisan once given the following disclosure.

The preferred 3D printing system and method for suppressing light refection and light scattering, according to various embodiments of the present invention, offers the following advantages: ease of use; reduced light reflection; reduced light scattering; reduced product completion time; reduced costs; increased performance; increased service lifetime; expanded use environments; and the ability to create different surface lattice and/or texture patterns specific to a particular wavelength range or optical device function. In fact, in many of the preferred embodiments, these advantages are optimized to an extent that is considerably higher than heretofore achieved in prior, known systems and methods for creating and coating optical devices.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a diagram of a main “build chamber” of an additive manufacturing unit, according to the present invention;

FIGS. 2A-2C are pictorial illustrations of various regular and irregular surface lattice and/or texture structures, according to the present invention;

FIG. 3 is a graphical bar graph of the reflectance versus surface lattice/texture type/coating combination, according to the present invention;

FIG. 4 is a graphical data table of the reflectance versus surface porosity test specimen type, according to the present invention;

FIG. 5A is a schematic illustration of a bi-directional reflectance distribution function (BRDF), according to the present invention;

FIG. 5B is a schematic illustration of the test apparatus used to acquire the BRDF, according to the present invention;

FIG. 6A is an illustration of a normal, as printed wall specimen type used to obtain the data in FIGS. 7 and 8, according to the present invention:

FIG. 6B is an illustration of an as printed, coated wall specimen type used to obtain the data in FIGS. 7 and 8, according to the present invention:

FIG. 6C is an illustration of a rough sprouts, as printed wall specimen type used to obtain the data in FIGS. 7 and 8, according to the present invention:

FIGS. 7A-7C are line graphs of reflected intensity, with units of Watts/steradian as a function of detector angle, with units of degrees, according to the present invention; and

FIGS. 8A-8C are other line graphs of reflected intensity, with units of Watts/steradian as a function of detector angle, with units of degrees, according to the present invention.

### DETAILED DESCRIPTION OF THE PREFERRED EMBODIMENTS OF THE INVENTION

In order to address the shortcomings of the prior, known systems and methods for creating and coating 3D printed articles, it would be desirable to provide printed surfaces having features with 3-dimensional size scales that range from less than 1 micron to greater than 10 mm (10,000 micron), by combining geometric design elements, such as surface lattices or textures, with other processes. Such processes may be special laser sintering processes, heat treatment processes, or chemical treatment processes. Also, the surface lattices or textures have characteristics, such as high surface area, that make them useful for certain applications, such as absorption and emission of electromagnetic radiation, suppression of light reflection and light scattering, and trapping of small particles. For example, the present invention is expected to have applicability in the field of optical assemblies, in particular, surface layers on the internal surfaces of optical assembly housings, in which stray light or scattered light beams are not desired to reach a particular optical sensor or receiving optical element.

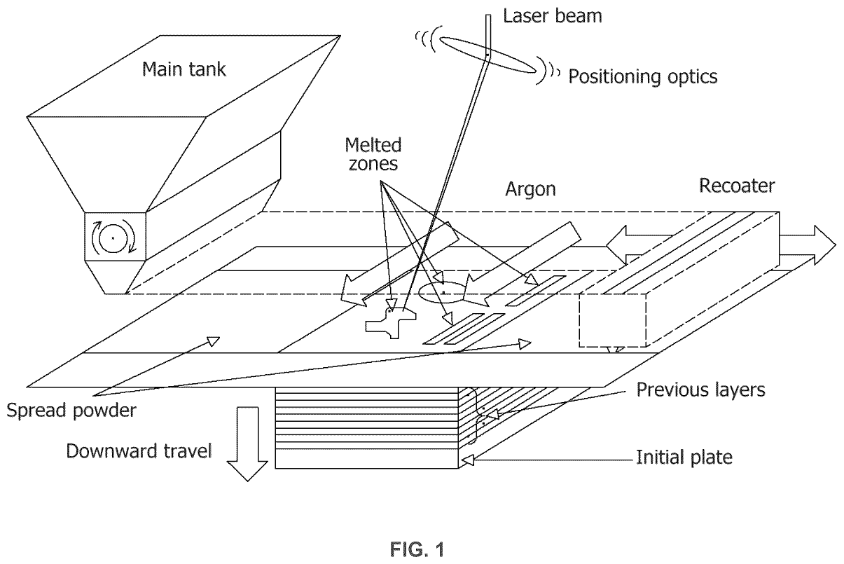

FIG. 1 shows a schematic illustration of a main “build chamber” of an additive manufacturing unit (AM unit). The main tank contains the raw-material powder, which is fed in appropriately sized, small batches to the recoater. The recoater spreads the powder evenly over the surface of the initial plate. The initial plate is a plate of material of the same or similar composition as the raw-material powder.

To minimize oxidation of the raw-material powder as it is heated by the scanning laser beam, air is displaced by a lateral flow of an inert gas, typically argon, which is directed across the build chamber volume and over the powder bed surface. This gas flow also carries powder ejecta and vapors away from the part(s) being additively manufactured, to achieve better material density, purity, and other physical and mechanical properties.

Beginning with an initial layer of raw-material powder spread onto the initial plate, which is typically attached to a heated, temperature-controlled, vertical motion platform, the additive manufacturing unit executes the computer-controlled scanning of the laser beam over the areas (melted zones) of the raw-material powder layer that are desired to be melted and resolidified into a portion of the part(s) desired to be produced from the raw-material. At the completion of the laser scanning for the initial layer, the initial plate is lowered by a distance equal to the desired raw-material powder layer thickness, and the recoater spreads a next layer of raw-material powder over the entire previous layer, including the previously laser-scanned part(s) area(s).

Upon completion of the powder recoating, the additive manufacturing unit executes the computer-controlled scanning of the laser beam over the areas of the raw-material powder layer that are desired to be melted and resolidified into the next area(s) of the next portion(s) of the part(s) desired to be produced from the raw-material. This cyclical process is repeated for as many cycles as is necessary to complete the additive manufacturing of the entire part(s) or product(s). At the end of the additive manufacturing process, a subsequent procedure for the removal of the initial plate with the attached, additively manufactured part(s) or product(s) is executed.

### Creation of Lattice Surface Structures

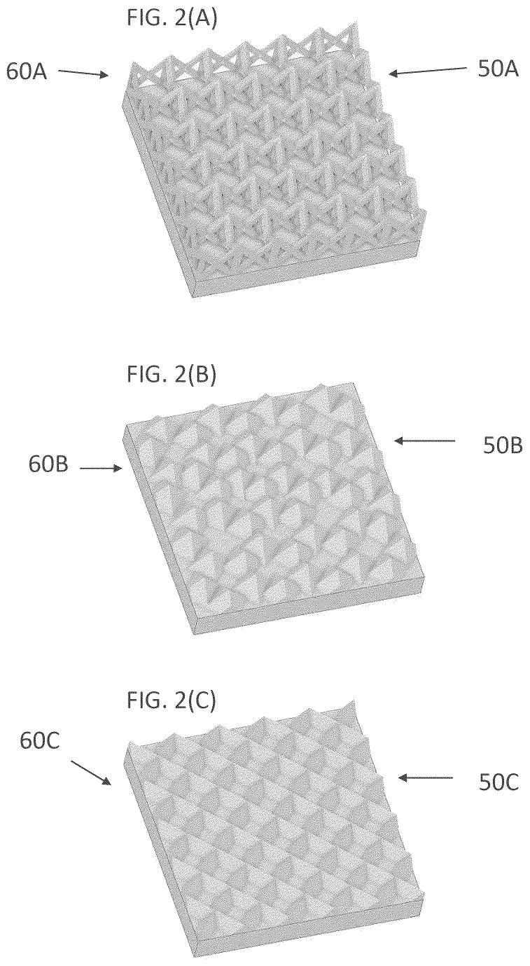

As discussed above, the present invention is related to the creation of a product having lattice surfaces, wherein the lattice features include features with 3-dimensional size scales that range from less than 1 micron to greater than 10 mm (10,000 micron), by combining geometric design elements, such as surface lattices, with other processes. Such processes may be special laser sintering processes, heat treatment processes, or chemical treatment processes. Furthermore, such surface lattices have characteristics, such as high surface area, that make them useful for certain applications, such as absorption and emission of electromagnetic radiation, suppression of light reflection and light scattering, and trapping of small particles. It is to be understood that, in one embodiment, the AM unit (FIG. 1) can be utilized to produce the part or product having surface lattices (FIGS. 2A-2C) located on an interior (and an exterior) of the part or product, as discussed in greater detail below.

As shown in FIGS. 2A-2C, a lattice is defined as either an arrangement of points in space with a defined, repeating “unit cell”, which is the volume, with defined dimensions in x, y and z directions, that encompasses the smallest repeat unit, or such an arrangement of points with accompanying physical, solid geometry populating or connecting the points. In crystallography, a lattice refers to the arrangement of groups of atoms in space. In structural design, a lattice refers to the physical members that connect at the points.

Surface lattices are lattices that originate at a surface, and do not extend far from the surface (such as the interior surface of the part or product). They can extend across the entirety of the surface, including non-planar, irregular surfaces, regardless of how large it is. Alternately, they can cover only a portion, or section, of a part or product, or multiple, separate portions, or sections, of a part or product.

Some types of surface lattices are as follows:
A. Beam-vertex type 50A—(FIG. 2A)
B. Protrusions type 50B—(FIG. 2B)
C. Intersecting rib type 50C—(FIG. 2C)

The advantages of surface lattices (50A-50C) pertinent to the present invention are their relatively high surface area, and their ability to both scatter light and absorb light, depending on the specific geometric features of the surface lattice (50A-50C).

Surface lattices (50A-50C) can also have graded unit cell sizes, such that the unit cell size increases or decreases in a direction, or periodically, across a surface.

Finally, surface lattices can also be superimposed upon each other, potentially achieving improved results over each individual constituent.

For parts 3D printed using 3D printing methods that involve layer-by-layer deposition of raw-material powder feedstock and the application of electromagnetic or subatomic particle beams (“energy beams”) (such as by AM unit (FIG. 1)) to effect the sintering or melting and re-solidification of the feedstock raw-material, the present invention consists of the combination of (1) “small” (0.5-5 mm) scale 3D printed features on a surface of a 3D printed part and (2) the deliberate application of energy beam “parameters” (primarily consisting of (i) power level, (ii) linear scan speed, and (iii) scanline spacing) that produce solidified material of substantially lower density than 100% (where 100% density is the typical objective for most part or component types) on the 3D printed part surface and/or throughout the small surface features (i.e., surface lattice patterns) of the 3D printed part, such that the small surface features with “porous” material characteristics are located on a surface of the printed part have features ranging from the 0.5-5 mm range down to the 0.1-0.01 mm range.

In one embodiment, the AM unit (FIG. 1) can be utilized to print a variety of different surface lattice patterns such that each surface lattice is constructed with a different sized and shaped unit cell. Furthermore, the surface lattice pattern can vary in terms of being regularly shaped or irregularly shaped.

In another embodiment, the AM unit (FIG. 1) can further be utilized to print a “coating” or other similar layer (60A-60C in FIGS. 2A-2C) having a desired surface porosity over the surface lattice pattern (50A-50C), wherein the layer having a desired surface porosity is created on the surface of the product. The surface lattice coating (or surface porosity coating) (60A-60C), which utilizes the energy beam parameters described earlier, which produce lower-density material with high “porosity” and small size-range (0.5-5 mm down to the 0.1-0.01 mm) 3-dimensional feature characteristics, can be printed over the surface lattice pattern (50A-50C) to provide an even greater reduction in light reflection and light scattering on the “coated” surface of the product. In one embodiment, the preferred coating thickness range is between 10-200 microns (0.01-0.20 mm).

In another embodiment, the AM unit (FIG. 1) can further be utilized to print a surface lattice pattern (50A-50C) that is created on the surface of the printed product, using the energy beam parameters described earlier. In this manner, lower-density material with high “porosity” and small size-range (0.5-5 mm down to the 0.1-0.01 mm) 3-dimensional feature characteristics are produced by printing of the entirety of the surface lattice pattern (50A-50C), to provide an even greater reduction in light reflection and light scattering on the “coated” surface of the printed product.

In another embodiment, the AM unit (FIG. 1) can be used to print the surface lattice pattern (50A-50C) and the “coating” or other similar layer (60A-60C in FIGS. 2A-2C) over the surface lattice pattern (50A-50C) as part of an overall process to print an object having the desired surface lattice pattern (50A-50C) and surface lattice coating (60A-60C).

In another embodiment, the printed product, having a completed surface lattice pattern (50A-50C) which includes “coating” or other similar layer (60A-60C) and optional utilization of the energy beam parameters described earlier, may undergo a thermal heat treatment process that results in some amount of phase transformation of the material, which may provide an even greater reduction in light reflection and light scattering on the “coated” surface of the printed product. For example, studies have shown that for the aluminum alloy, AlSi10Mg, heat treatment within certain temperature ranges and for certain time periods can result in the formation of silicon-rich regions on the surfaces of parts printed from this material. These silicon-rich regions may have beneficial effects on the reduction in light reflection and light scattering on the “coated” surface of the printed product. Furthermore, certain chemical treatments of the heat-treated parts may result in chemical reactions with the silicon-rich regions, resulting in further modification of the surfaces of parts printed from this material. These chemically modified regions may have beneficial effects on the reduction in light reflection and light scattering on the “coated” surface of the printed product.

### Reflectivity and Scattering Test Results

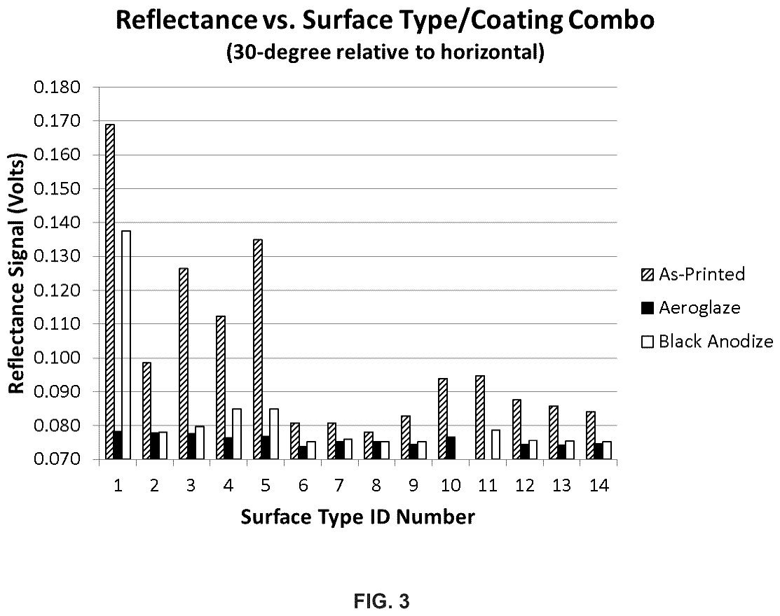

To demonstrate the novelty of the present invention, attention is directed to FIGS. 3-8C. With respect to FIG. 3, surface test specimens of different surface lattice types were subjected to a beam of 660 nm wavelength (red) light at an incidence angle of 30 degrees using a conventional reflectometer (not shown). The numbers on the x-axis of the plot represent test specimens having different surface lattice types. Plotted for each surface lattice type is the reflectance intensity signal value obtained for that surface in an (A) un-coated (as-printed) condition (hatched bars), (B) a specialty commercial “Aeroglaze” coated condition (solid bars), and (C) a black-anodize coated condition (un-filled bars). It is to be understood that the black-anodize coated specimens and the commercial “Aeroglaze” coated specimens were coated according to the well-known coating techniques discussed earlier.

As shown in FIG. 3, the bars corresponding to the Aeroglaze coated specimens are generally the lowest in value, indicating the lowest light reflectance. The bars corresponding to the black-anodize coated specimens are generally the next lowest, and, in some cases, are as low as the Aeroglaze specimens. The bars corresponding to the as-printed, un-coated specimens are generally the highest in value, as they have no special coating to help reduce the reflectance. However, for several surface lattice types of the un-coated specimens, the reflectance values are nearly as low as the other two, coated surface types. It should be noted that surface type 1 is a “normal” 3D printed surface with no surface lattice.

It was observed that all of the as-printed surface lattice types have lower reflectance than the type 1 surface with the black-anodize coating. It was further observed that surface lattice type 8 demonstrated a reflectance that is slightly lower than the type 1 surface with the Aeroglaze coating. Therefore, in some cases, the as-printed surface lattice alone can outperform the coated “normal” surface.

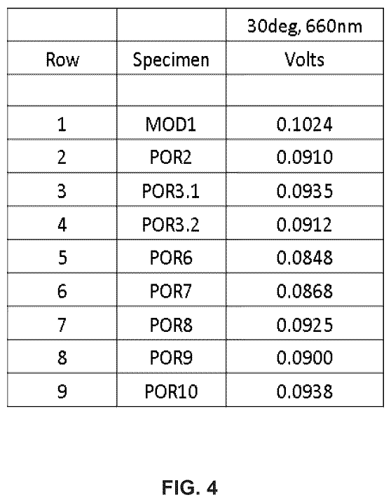

Other test specimens were produced to deliberately have a porous surface compared to surfaces 3D printed using “normal” or “standard” laser parameters. The reflectance data, acquired under the same test conditions as the data presented in FIG. 3, is shown in FIG. 4. These specimens contained no surface lattices—all were regular, flat surfaces. The first specimen in the table, denoted as “MOD1”, was produced using “normal” or “standard” laser parameters. All of the other specimens were produced using laser parameters that were changed to cause significant porosity at and near the surface. As shown in FIG. 4, the data obtained demonstrates that all deliberately porous specimens exhibited lower reflectance than the normal one. For this set of specimens, the one with the lowest reflectance was approximately 20% lower than the normal one.

Based upon the test results shown in FIGS. 3 and 4, the present invention demonstrates that these lattice structures can be nearly as-effective and, in some cases, equally or more-effective at suppressing specular surface reflection of incident light beams as certain known specialty, reflection-suppressing surface coatings and/or machined-in features.

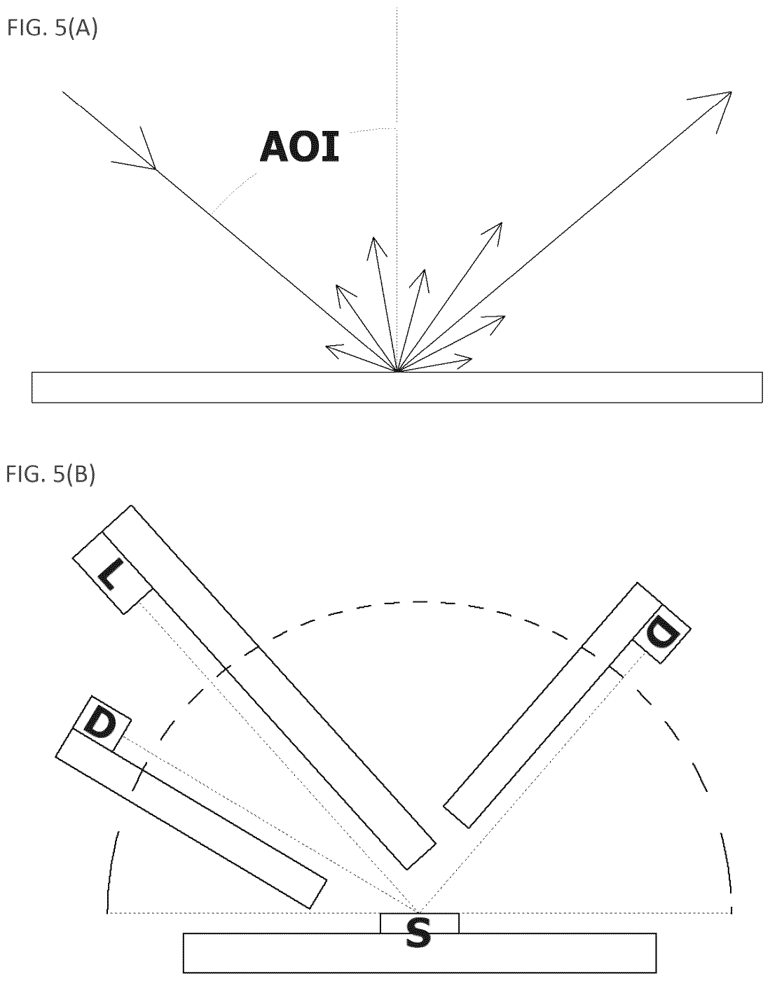

In order to further demonstrate the uniqueness of the present invention, the following is presented. While straightforward to measure, specular reflectance represents only a portion of the light that can be reflected, or scattered, by a surface. Besides this classical “angle of reflection equals angle of incidence” mode of reflection, a surface can scatter light over the entire hemisphere above it. Therefore, measuring not only the specular reflectance intensity, but also the diffuse reflectance intensity of a surface over the entire hemisphere is a way of more completely assessing the reflectance suppression performance of a surface. However, measurement instruments that can capture the reflected light over an entire hemisphere are not common. A suitable alternative is to measure the reflected intensity within a plane normal to the surface under test, in which an irradiating source can be positioned at a specific angle of incidence to the surface under test, and a light intensity detector can be positioned at an angle ranging from 0 degrees to 180 degrees within the same plane. The data so acquired is sometimes referred to as the bi-directional reflectance distribution function, or BRDF (FIG. 5(A)). A diagram of the test apparatus used to acquire this data is shown in FIG. 5(B). Using this arrangement, both the specular and diffuse reflectance of a surface can be assessed.

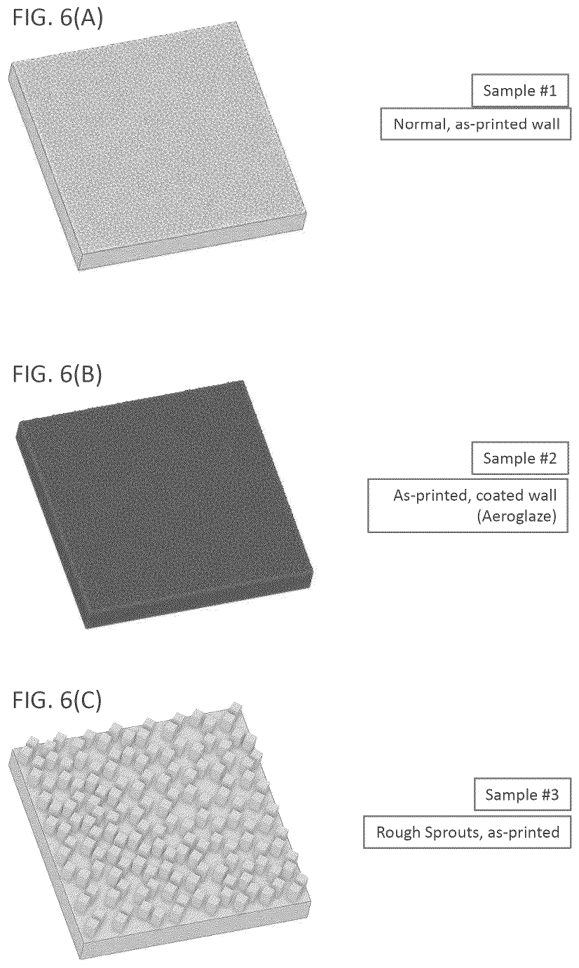

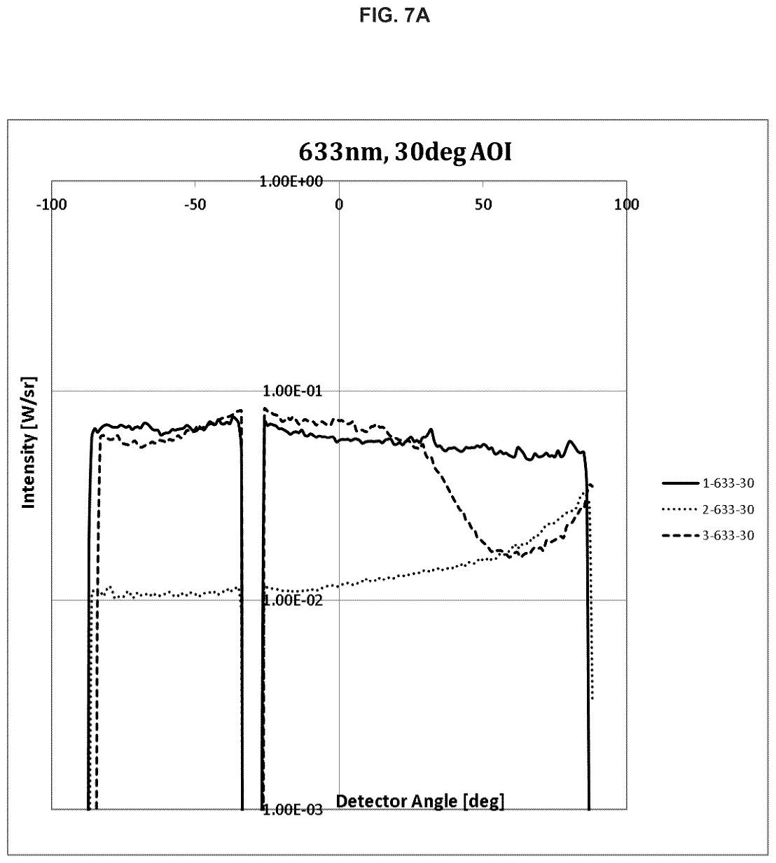

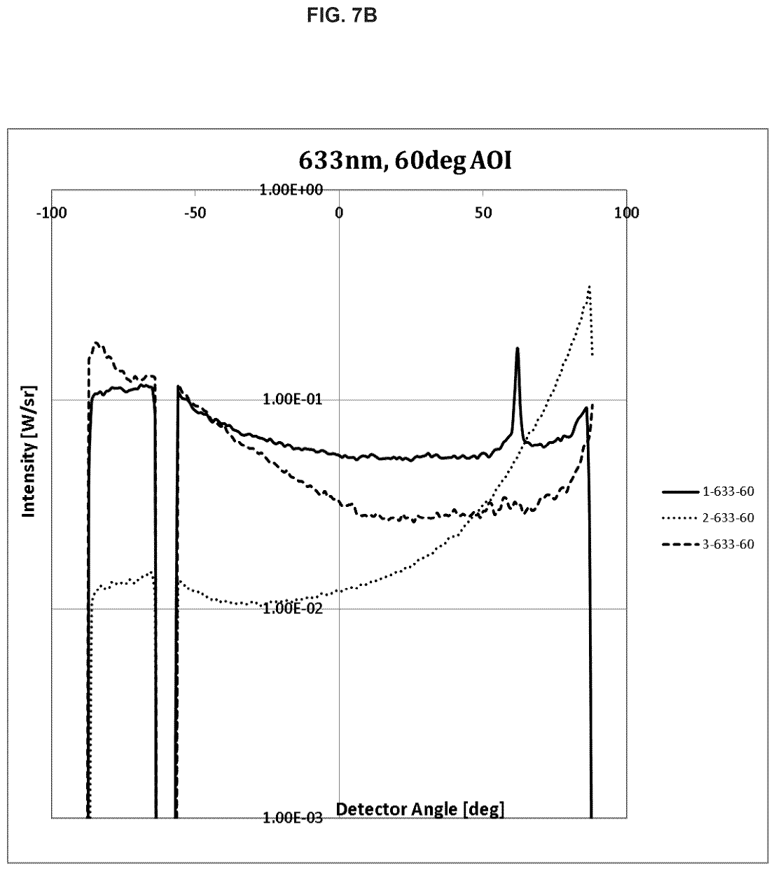

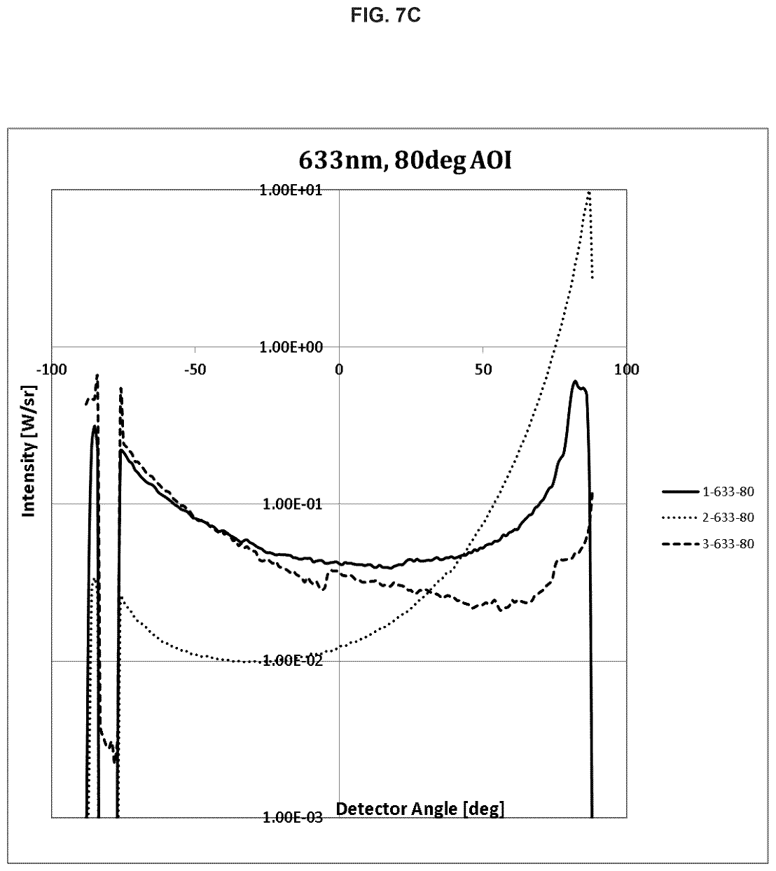

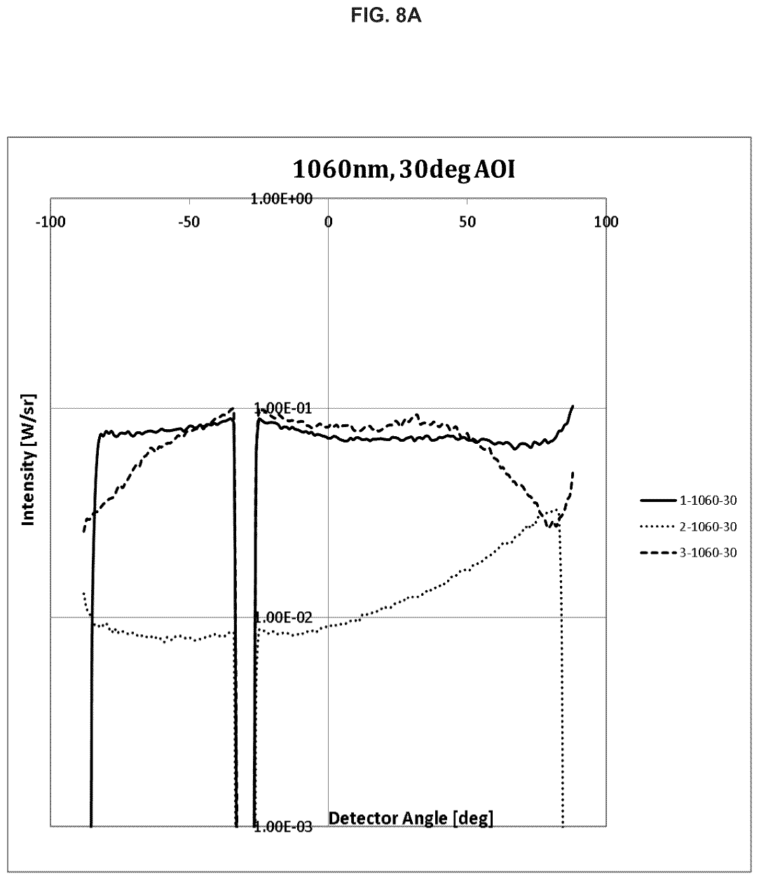

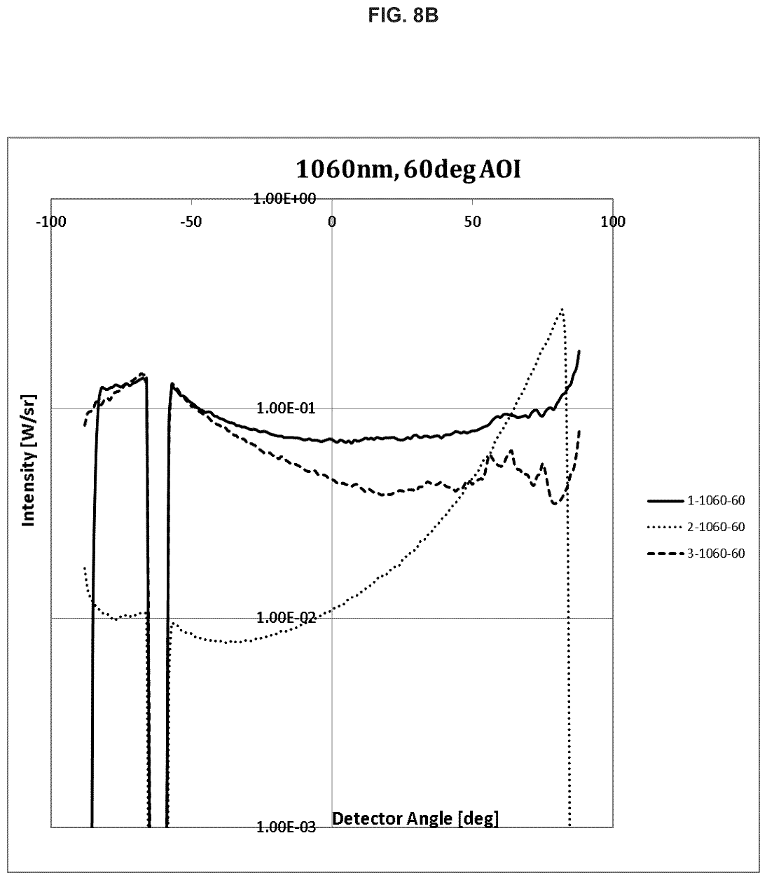

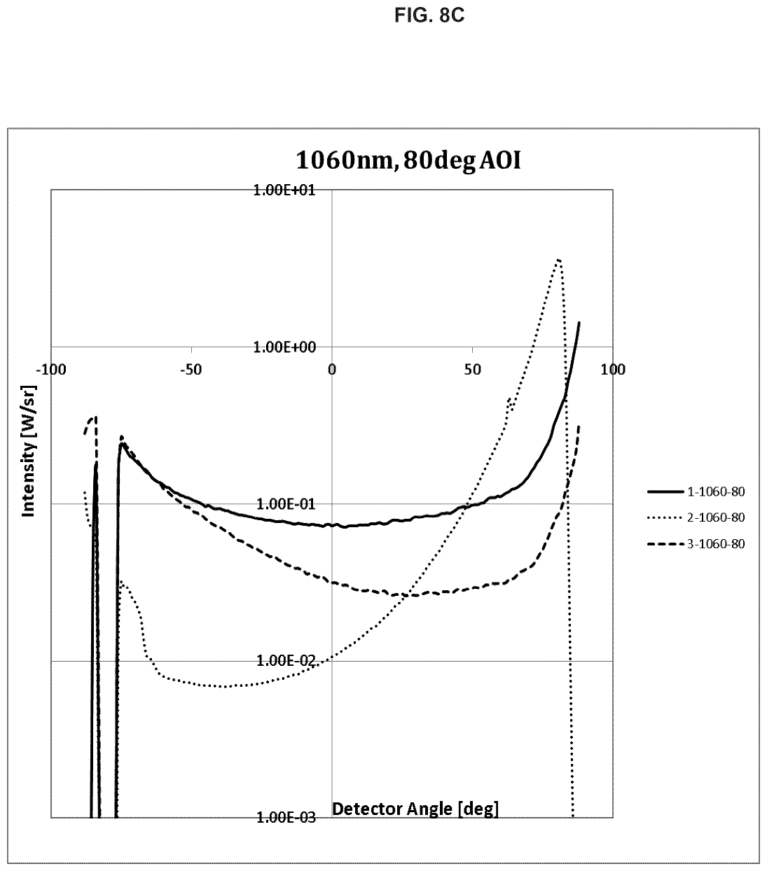

A subset of specimen types for which the specular reflectance data was shown in FIG. 3 were analyzed to obtain their BRDF data. These specimen types are shown in FIGS. 6A-6C. Sample #1 was a normal 3D printed surface (FIG. 6A), Sample #2 was a normal 3D printed surface with the Aeroglaze coating applied (FIG. 6B), and Samples #3-5 were surface lattices that were 3D printed according to the present invention with laser parameters that resulted in different porosities of the surface lattice 3D features. The chosen surface lattice types were the same types that gave the best results in FIG. 3. Sample #3 was a type of rough, irregular protrusions (FIG. 6C), Sample #4 was a pyramidal protrusions type, and Sample #5 was an intersecting grid type. All five (5) sample types were analyzed at different irradiation wavelengths, and at three different irradiation angles of incidence (AOI). Results for the wavelength 633 nm are shown in FIGS. 7A-7C, and results for the wavelength 1060 nm are shown in FIGS. 8A-8C. Additional results for other wavelengths were obtained but are not shown.

The data shown in the charts of FIGS. 7A-7C and 8A-8C are graphs of reflected intensity, with units of Watts/steradian as a function of detector angle, with units of degrees. Zero degrees is defined as normal (or vertical) to the horizontal plane of the sample surface. Negative ninety (−90) degrees corresponds to the detector positioned parallel to the surface of the sample, behind the illumination source (FIG. 5B), and positive ninety (90) degrees corresponds to the detector being located parallel to the surface of the sample, in front of the illumination source. The detector support arm includes a pivot that allows the detector to be positioned (typically using a position-adjusting motor) at any angle between −90 deg and 90 deg. With the illumination source set to an angle of incidence (AOI) of 30 deg, 60 deg and 80 deg, the reflected intensity was obtained over the entire angular range of the detector from −90 deg to 90 deg. Each graph exhibits a “drop” of about 10 deg angular range, which corresponds to the AOI of the illumination source, due to the obstruction of the irradiating beam by the detector. This is typical and normal.

Each data chart includes graphs (FIGS. 7A-7c and 8A-8C) for the reflected intensity for the first three of the five samples discussed above with respect to FIGS. 6A-6C. The legend to the right of each chart identifies the data graphs by different line types (solid, dotted, and dashed). A first observation is that the reflected intensity of Sample #2-633-30 (Aeroglaze coating) is less than all of the other samples by about an order of magnitude from −90 deg to about 0 deg. From 0 deg to 90 deg, the reflected intensity of Sample #2-633-30 increases, and, in most cases (FIG. 7A being the exception), becomes greater than the reflected intensity of all of the other samples. A second observation is that from 0 deg to 90 deg (and also at detector angles from 0 deg to about −40 deg in most cases), the reflected intensity of Sample #3-633-30 (3D printed lattice surface having rough, irregular protrusions and a 3D printed coating) is less than Sample #1-633-30 (normal 3D printed surface with no coating). A third observation is that as the AOI of the incident beam increases, from 30 deg to 60 deg to 80 deg, in each of FIGS. 7A-7C and 8A-8C, the amount by which the reflected intensity of Sample #2-633-30 exceeds the other samples from approximately 50 deg to about 90 deg increases significantly, which is mainly due to the increase in the reflected intensity of Sample #2-633-30 (whereas the reflected intensities of the other samples remain relatively constant in comparison). A fourth observation is that in FIG. 7B (60 deg AOI), at 60 deg, the reflected intensity of Sample #3-633-30 is slightly less than Sample #2-633-30. This agrees with the results from FIG. 3, in which the specular reflectance intensity of at least one of the surface lattice samples was less than the Aeroglaze coated normal printed surface.

In summary, the BDRF data demonstrate that the 3D printed surface lattices having a porous surface lattice coating (or surface porosity coating) reflect significantly less light than Aeroglaze coated surfaces at medium to high forward angles, which would typically be the direction of light beam entry into an optical device or component. This characteristic would reduce the amount of stray or scattered light that could possibly enter an optical device, thereby resulting in improved performance of the device.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below.” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

All of the features disclosed in this specification may be combined in any combination. Thus, unless expressly stated otherwise, each feature disclosed is only an example of a generic series of equivalent or similar features.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other modifications and implementations will occur to those skilled in the art without departing from the spirit and the scope of the invention. Accordingly, the description hereinabove is not intended to limit the invention.

Therefore, provided herein is a new and improved 3D printing system and method for suppressing light refection and scattering, which according to various embodiments of the present invention, offers the following advantages: ease of use; reduced light reflection; reduced light scattering; reduced product completion time; reduced costs; increased performance; increased service lifetime; expanded use environments; and the ability to create different surface lattice patterns.

In fact, in many of the preferred embodiments, these advantages of ease of use; reduced light reflection; reduced light scattering; reduced product completion time; reduced costs; increased performance; increased service lifetime; expanded use environments; and the ability to create different surface lattice patterns are optimized to an extent that is considerably higher than heretofore achieved in prior, known systems and methods for creating and coating 3D printed articles.

What is claimed is:

1. A method of using additive manufacturing (AM) devices, comprising the steps of:
providing at least one additive manufacturing (AM) unit adapted to produce a product having 3-dimensional surface lattices using additive manufacturing (AM);
determining a desired surface lattice to print upon a surface of the product;
printing the desired surface lattice on the surface of the product, wherein the desired surface lattice is capable of reducing and controlling a light reflection and a light scattering of light that interacts with the surface lattice on the product;
determining a desired surface porosity coating to print upon the desired lattice surface; and
printing the desired surface porosity coating upon the desired surface lattice, wherein the desired surface porosity coating is capable of further reducing a light reflection and a light scattering of light that interacts with the surface lattice.

2. The method, according to claim 1, wherein the method further comprises the step of:
thermal heat-treating the desired surface porosity coating, wherein the thermal heat treating creates a phase transformation of at least a portion of the desired surface porosity coating such that the heat-treated portion of the desired surface porosity coating provides a reduction in light reflection and light scattering on the surface lattice.

3. The method, according to claim 1, wherein the desired surface lattice further comprises:
surface features located on the desired surface lattice ranging from a 0.5-5 mm range to a 0.1-0.01 mm range.

4. The method, according to claim 1, wherein the desired surface lattice further comprises:
an arrangement of points in space with a defined, repeating unit cell, which is a volume, with defined dimensions in x, y and z directions, that encompasses a smallest repeat unit; or
an arrangement of points with an accompanying physical, solid geometry populating or connecting the arrangement of points.

5. The method, according to claim 4, wherein the desired surface lattice further comprises:
a beam-vertex type surface lattice;
a protrusions type surface lattice; or
an intersecting rib type surface lattice.

6. The method, according to claim 2, wherein the method further comprises:
chemically treating the thermal heat-treated desired surface porosity coating, wherein the chemical treating provides a reduction in light reflection and light scattering on the surface lattice.

7. A system for using additive manufacturing (AM) devices to print products having 3-dimensional surface lattices for use in the reduction of light reflection and light scattering by the product, comprising:
at least one additive manufacturing (AM) unit adapted to produce a product having 3-dimensional surface lattices using additive manufacturing (AM), wherein the product comprises;
a desired surface lattice which is printed upon a surface of the product, wherein the desired surface lattice is capable of reducing and controlling a light reflection and a light scattering of light that interacts with the surface lattice on the product, and
a desired surface porosity coating which is printed upon a surface of the desired surface lattice, wherein the desired surface porosity coating is capable of further reducing a light reflection and a light scattering of light that interacts with the surface lattice.

8. The system, according to claim 7, wherein the desired surface porosity coating further comprises:
a thermal heat-treated layer located upon a portion of the desired surface porosity coating such that the thermal heat-treated layer provides a reduction in light reflection and light scattering on the surface lattice.

9. The system, according to claim 7, wherein the desired surface lattice further comprises:
surface features located on the desired surface lattice ranging from a 0.5-5 mm range to a 0.1-0.01 mm range.

10. The system, according to claim 7, wherein the desired surface lattice further comprises:
an arrangement of points in space with a defined, repeating unit cell, which is a volume, with defined dimensions in x, y and z directions, that encompasses a smallest repeat unit; or
an arrangement of points with an accompanying physical, solid geometry populating or connecting the arrangement of points.

11. The method, according to claim 10, wherein the desired surface lattice further comprises:
a beam-vertex type surface lattice;
a protrusions type surface lattice; or
an intersecting rib type surface lattice.

12. The system, according to claim 8, wherein the desired surface porosity coating further comprises:
a chemically treated layer located upon a portion of the thermal heat-treated layer such that the chemically treated layer provides a reduction in light reflection and light scattering on the surface lattice.

13. A method of printing products having 3-dimensional lattice surfaces for use in the reduction of light reflection and light scattering by the product, comprising the steps of:
providing at least one additive manufacturing (AM) unit adapted to produce a product having 3-dimensional lattice surfaces using additive manufacturing (AM);
determining a desired surface lattice to print upon a surface of the product;
printing the desired surface lattice on the surface of the product, wherein the desired surface lattice is capable of reducing and controlling a light reflection and a light scattering of light that interacts with the surface lattice on the product;
determining a desired surface porosity coating to print upon the desired lattice surface; and
printing the desired surface porosity coating upon the desired surface lattice, wherein the desired surface porosity coating is capable of further reducing a light reflection and a light scattering of light that interacts with the surface lattice.

14. The method, according to claim 13, wherein the method further comprises the step of:
thermal heat-treating the desired surface porosity coating, wherein the thermal heat-treating creates a phase transformation of at least a portion of the desired surface porosity coating such that the heat-treated portion of the desired surface porosity coating provides a reduction in light reflection and light scattering on the surface lattice.

15. The method, according to claim 13, wherein the desired surface lattice further comprises:
surface features located on the desired surface lattice ranging from a 0.5-5 mm range to a 0.1-0.01 mm range.

16. The method, according to claim 13, wherein the desired surface lattice further comprises:
an arrangement of points in space with a defined, repeating unit cell, which is a volume, with defined dimensions in x, y and z directions, that encompasses a smallest repeat unit; or
an arrangement of points with an accompanying physical, solid geometry populating or connecting the arrangement of points.

17. The method, according to claim 16, wherein the desired surface lattice further comprises:
a beam-vertex type surface lattice;
a protrusions type surface lattice; or
an intersecting rib type surface lattice.

18. The method, according to claim 14, wherein the method further comprises:
chemically treating the thermal heat-treated desired surface porosity coating, wherein the chemical treating provides a reduction in light reflection and light scattering on the surface lattice.
